(19) United States
(12) Patent Application Publication
(10) Pub. No.: US 2026/0273763 A1
(43) Pub. Date: Sep. 17, 2026

(54) Method and System for Feeding Twistlocks

(71) Applicant: ABB Schweiz AG, Baden (CH)

(72) Inventor: Ye Tian, Shanghai (CN)

(21) Appl. No.: 19/676,092

(22) Filed: May 13, 2026

Related U.S. Application Data
(63) Continuation of application No. PCT/CN2023/131482, filed on Nov. 14, 2023.

(51) Int. Cl. B25J 9/16; B25J 15/06; B65D 90/00; B65G 47/14; B65G 59/04

(52) U.S. Cl. CPC B25J 9/1697; B25J 9/1633; B25J 9/1638; B25J 9/1661; B25J 9/1666; B25J 15/0608; B65G 47/1485; B65G 59/04; B65D 90/0013

(57) ABSTRACT

Embodiments of the present disclosure provide method and system for feeding twistlocks. A method for feeding twistlocks by a robot, including: determining a first twistlock from a heap including a plurality of twistlocks based on an image of the heap, determining a primary pick-up point for the first twistlock, moving a pick-up arrangement of the robot to a first position where the primary pick-up point is accessible by the pick-up arrangement, and separating the first twistlock from the heap.

### TECHNICAL FIELD

Embodiments of the present disclosure generally relate to twist locks feeding, and more specifically, to a method and system for feeding twistlocks as well as a robot for feeding twistlocks.

### BACKGROUND

Twistlocks may be used for locking stack containers in place on a container ship, semi-trailer or rail carriage. A typical twistlock may comprises a cone, a housing, and a handle configured to adapt the orientation of the cone. To facilitate the operation by the user to pull or push the handle, the handle generally may be arranged to extend a longer distance away from the housing.

When a plurality of twistlocks are piled up, though one twistlock is in the view from outside a heap comprising a plurality of twistlocks, the handle of said one twistlock may be under one or more other twistlocks and entangled with the one or more other twistlocks. There are challenges to separate one twistlock from the heap comprising the plurality of twistlocks.

### SUMMARY

Embodiments of the present disclosure provide a method for feeding twistlocks, a robot and a feeding system to at least facilitate the separation of one twistlock from the heap comprising a plurality of twistlocks.

In a first aspect, a method for feeding twistlocks by a robot is provided. The method comprises determining a first twistlock from a heap comprising a plurality of twistlocks based on an image of the heap, determining a primary pick-up point for the first twistlock, moving a pick-up arrangement of the robot to a first position where the primary pick-up point is accessible by the pick-up arrangement, and separating the first twistlock from the heap.

In this way, the process of separating the twistlock from the heap may be independent of further processes of automatic feeding, including delivering the separated twistlock to a next process performed by a further robot. Furthermore, when the process of separating the twistlock from the heap is not successfully proceeded, the further processes of automatic feeding may be suspended to wait and proceed to perform operation to the twistlock from other sources.

The usage of the pick-up arrangement for feeding twistlocks may facilitate flexibility of holding and releasing twistlocks. By configuring the pick-up arrangement to operate independent of the end effector of the robot, if any, the twistlock may be conveniently accessed by the pick-up arrangement. In this way, any collision between the twistlock and the robot may be avoided.

According to one or more embodiments, the method further comprises: placing the first twistlock on a workbench, adjusting an orientation of the placed first twistlock, moving the first twistlock with the adjusted orientation from the workbench to a fixture. The twistlock with the adjusted orientation may facilitate the process of installing the twistlock to a container, and thereby the automatic installation may be enabled.

According to one or more embodiments, the method further comprises: moving, in response to a determination that the first twistlock is lifted, the first twistlock to a fixture. The separated twistlock may be directly moved to a fixture. The robot may focus on the operation of separating the twistlock from the heap, and the efficiency of feeding twistlocks may be advanced.

According to one or more embodiments, the step of moving the first twistlock to the fixture comprises: determining whether an additional twistlock is lifted together with the first twistlock. The unreliable connection between the additional twistlock and the first twistlock held by the pick-up arrangement may put the operating area at risk. By detecting the existence of the additional twistlock during the moving of the first twistlock, the robot may determine whether to proceed to move the first twistlock, and/or generate an alarm to notify the operator that the operating area is at risk.

According to one or more embodiments, the method further comprises the steps of determining a second twistlock from the heap based on the image, and determining a secondary pick-up point for the second twistlock. The robot may determine whether the first twistlock or the second twistlock is the target twistlock to be separated from the heap. This determination may be based on evaluating the accessibility to the primary pic-up point and the secondary pick-up point. Alternatively, the second twistlock may be regarded as a candidate twistlock to be lifted, when the first twistlock is not lifted.

According to one or more embodiments, the method further comprises the steps of moving, in response to a determination that the first twistlock is not lifted, the pick-up arrangement of the robot to a second position where the secondary pick-up point is accessible by the pick-up arrangement. It ensures that at least a twistlock may be separated from the heap, and thereby the stability of automatic feeding may be facilitated.

According to one or more embodiments, the image of the heap comprising the plurality of twistlocks comprises characteristic information representing a height distribution diagram of the heap. The characteristic information may be taken into account in determining the first twistlock.

According to one or more embodiment, determining the first twistlock from the heap comprises: selecting, based on the characteristic information, a twistlock at or near a peak value in the height distribution diagram of the twistlocks as the first twistlock. In this way, the distance between the first twistlock and the pick-up measurement may be minimized, and thereby the efficiency of separating the twistlock may be facilitated.

According to one or more embodiments, the first twistlock is a twistlock closest to a peak of the heap. The twistlock closest to a peak of the heap, empirically, may be convenient for the pick-up arrangement to access and hold.

According to one or more embodiments, the image comprises the image captured from right above the heap. The captured image may comprise a series of images.

According to one or more embodiments, the image comprises an image captured by a 3D camera.

According to one or more embodiments, the method further comprises steps of: increasing, in response to a determination that the first twistlock is not lifted with a predetermined force, the predetermined force till the first twistlock is lifted, releasing the lifted first twistlock back to the heap, determining a further twistlock from the heap comprising the released twistlock based on a further image, and determining a primary pick-up point for the further twistlock. By this implementation, the architecture of the heap may be updated, and thus some twistlocks which might be suitable for being separated may be uncovered. In this way, it avoids the scenario that the robot stops operation as there is no twistlock suitable for being lifted.

According to one or more embodiment, the pick-up arrangement comprises a connecting member comprising an electromagnet configured to generate a magnetic attraction force.

In a second aspect, a robot configured to perform a method of the first aspect is provided.

In a third aspect, a feeding system is provided. The feeding system comprises a robot of the second aspect, and a conveyor configured to deliver a twistlock fed by the robot.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent the same components.

FIG. 1 illustrates a perspective view of a conventional twistlock;

FIG. 2A illustrates a robot provided by the present disclosure;

FIG. 2B shows the components of the robot illustrated in FIG. 2A;

FIG. 2C illustrates a flow diagram of the processes of the method provided by the present disclosure;

FIG. 3 shows an example image of a heap comprising a plurality of twistlocks captured by the camera;

FIG. 4 illustrates the processes of moving the pick-up arrangement and separating the twistlock from the heap;

FIG. 5 illustrates a flowchart of further processes performed by the robot in FIG. 2A after the twistlock is separated from the heap;

FIGS. 6A-6C illustrate the processes of performing operations to the twistlock by the robot in FIG. 2A;

FIG. 7 illustrates the further processes of performing operations to the twistlock by the robot in FIG. 2A;

FIG. 8 illustrates a flowchart of further processes performed by the robot provided by the present disclosure;

FIG. 9 illustrates a flowchart of further processes performed by the robot provided by the present disclosure; and

FIG. 10 illustrates a flowchart of further processes performed by the robot provided by the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

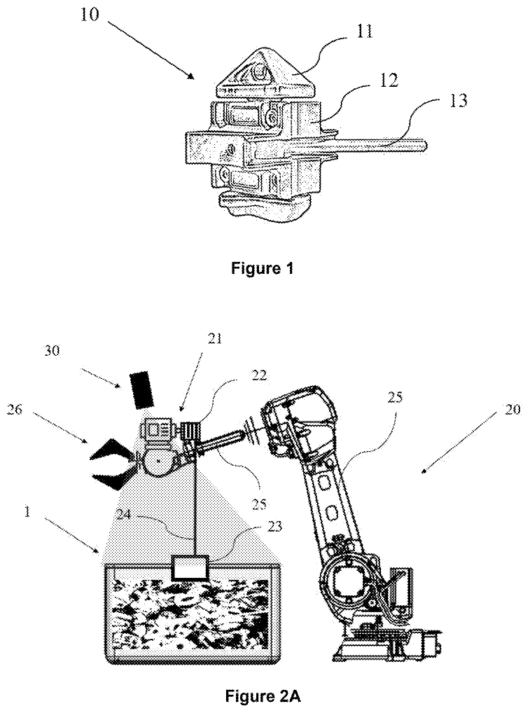

FIG. 1 illustrates a perspective view of a conventional twistlock. As shown, a twistlock 10 comprises a cone 11, a housing 12 and a handle 13. The handle 13 may be configured to adjust the orientation of the cone 11. The handle 13 has a length much greater than the size of the housing 12. When the twistlocks have been detached from e.g. containers, the twistlocks may be placed on a site, such as a bin with a volume for accommodating a number of twistlocks, and thereby a heap comprising a plurality of twistlocks may be formed.

When there are a number of twistlocks, one of the twistlocks or a part thereof, e.g. a handle 13 of the twistlock 10, may be positioned below other twistlocks. Though the twistlock may be visible from above the heap or other perspectives, it does not necessarily mean that twistlock may be picked up easily. This may be because the twistlock or a part thereof may be entangled with other twistlocks. Generally, the operation of picking up one twistlock is done by human. In addition, the inventor observes that there are some drawbacks in the process of picking up the twistlock using an end effector of a robot. In the implementation that a gripper serves as the end effector of the robot, the operating path of the gripper to reach and grasp the target twistlock may be blocked by the twistlocks entangled with the target twistlock. Moreover, when the target twistlock is positioned near a wall of a bin accommodating the target lock, the operating path of the gripper to reach and grasp the target twistlock may be blocked by the wall of the bin. During the operation, there is a potential risk that the robotic arm to which the end effector being coupled may collide with the twistlocks.

The present disclosure intends to provide a method and a robot to separate one twistlock from a heap comprising a plurality of twistlocks. By utilizing the method and robot provided by the present disclosure, a feeding system for automatically feeding twistlocks may also be achieved.

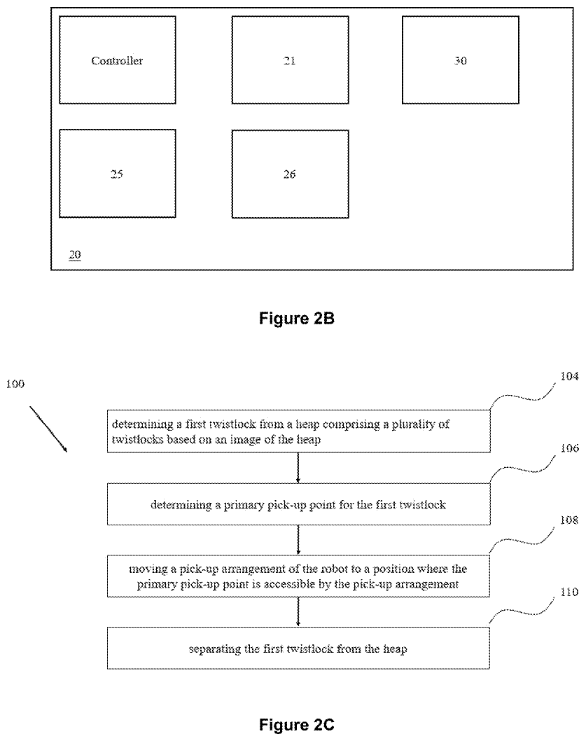

FIG. 2A illustrates a robot provided by the present disclosure. FIG. 2B shows the components of the robot illustrated in FIG. 2A.

Referring to FIG. 2A, a plurality of twistlocks may be accommodated by a bin 1. The robot 20 may be configured to separate one twistlock from a heap comprising a plurality of twistlocks in the bin 1. The robot 20 may comprise a pick-up arrangement 21, two robotic arms 25, an end effector 26, a camera 30, and a controller. The pick-up arrangement 21 may comprise a motor 22, a connecting member 23 configured to hold and release a twistlock, and lines 24 connected between the motor 22 and the connecting member 23 and configured to supply power to the connecting member 23. The motor 22 may be configured to wind/unwind the lines 24, and thereby the distance of the connecting member 23 relative to the motor 22 may be controlled. In one embodiment, the connecting member 23 comprises an electromagnet, which will be discussed in more detail below with reference to FIG. 4.

In further embodiments, the robots having the same pick-up arrangement 21 may have three or more robotic arms.

Referring to FIG. 2B, the controller may be connected to the pick-up arrangement 21, the robotic arms 25, the end-effector 26, and the camera 30 via wires or wirelessly. The controller may be configured to control the operations of the pick-up arrangement 21, two robotic arms 25, and the end effector 26. The controller may comprise a processor, and a memory coupled to the processor. Computer program instructions may be stored on the memory. Responsive to the execution of the stored computer program instructions by the processor, the image of the heap may be processed to determine the target twistlock. A control signal for the pick-up arrangement 21, the robotic arms 25, and the end-effector 26 may be generated by the processor when the stored computer program instructions are executed.

In one embodiment, the camera 30 may comprise a 3D camera. The 3D camera may be configured to record the views of the heap comprising a plurality of twistlocks from at least two perspectives. The views recorded from the at least two perspectives may be used to determine the distance from each of the plurality of twistlocks in the heap to the camera. For example, the distance between the camera and the twistlock may be determined based on the difference between the same twistlocks seen through the different perspectives. A height distribution diagram may be generated by the 3D camera based on the determined distance from the twistlock to the camera, and the position of the 3D camera. In one embodiment, the image comprising characteristic information representing a height distribution diagram of the heap may be transmitted from the 3D camera to the controller of the robot.

In one embodiment, the robot further comprises a user interface. The image captured by the camera 30 and the generated height distribution diagram may be displayed on the user interface.

FIG. 2C illustrates a flow diagram of the processes of the method provided by the present disclosure.

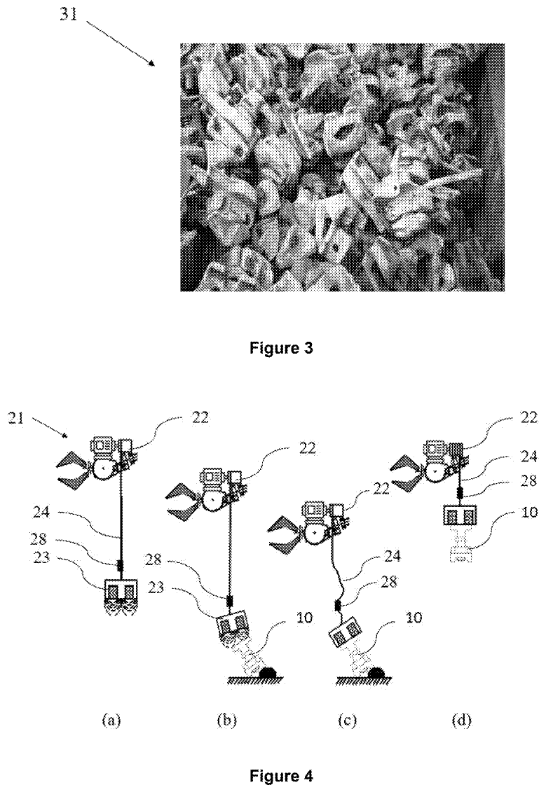

At block 104, a first twistlock from a heap comprising a plurality of twistlocks may be determined based on an image of the heap. FIG. 3 shows an example image of a heap comprising a plurality of twistlocks captured by the camera. As shown, several twistlocks are visible in the image 31.

The controller of the robot 20 may determine one twistlock from the heap as the first twistlock based on the image 31. In one embodiment, the controller may be configured to build a model mapping the twistlocks in the image to the actual twistlocks in the heap, and further configured to select the first twistlock based on the mappings in the model. The first twistlock may correspond to the twistlock having a coordinate located at a center of the image. Alternatively, the first twistlock may correspond to the twistlock having a coordinate located adjacent to an edge of the image. In this way, the process of building mappings mentioned above may be omitted.

In another embodiment, in case that the characteristic information representing the height distribution diagram as discussed above is received, the coordinate of each twistlock may be determined and assigned a level value of the height distribution diagram by the controller of the robot. The process of determining the first twistlock from the heap based on the image may comprise, selecting a twistlock at or near a peak value in the height distribution diagram of the twistlocks as the first twistlock based on the characteristic information.

In a further embodiment, a twistlock closest to a peak of the heap may be selected as the first twistlock. In this way, the process of generating a height distribution diagram may be omitted. The controller of the robot may determine the twistlock closest to a peak of the heap based on 3D dimension information of the heap. The 3D dimension information of the heap may be determined based on the image captured by the above-mentioned 3D camera.

At block 106, a primary pick-up point for the first twistlock may be determined. In one embodiment, by the controller of the robot 20, a coordinate graph for the twistlocks in the heap may be produced based on the image. The coordinate of the first twistlock may be determined as the primary pick-up point. Alternatively, a point in the area around the coordinate of the first twistlock may be determined as the primary pick-up point.

At block 108, the pick-up arrangement 21 of the robot 20 may be moved to a first position where the primary pick-up point is accessible by the arrangement 21. The first position may be located over the primary pick-up point. At block 110, the first twistlock may be separated from the heap by the robot 20, by lifting or dragging or in combination. The processes in blocks 108 and 110 will be discussed in more detail below with reference to FIG. 4.

FIG. 4 illustrates the processes of moving the pick-up arrangement and separating the twistlock from the heap.

As shown in FIG. 4, the transition from phase (a) to phase (b) illustrates the process of moving the pick-up arrangement to a position where the twistlock is accessible by the pick-up arrangement 21, in particular by the connecting member 23. In the implementation of FIG. 4, the connecting member 23 comprises an electromagnet. The electromagnet may be configured to generate magnetic attraction force. The magnitude of the magnetic attraction force generated by the electromagnet may be determined as a function of the current supplied to the electromagnet. The current supplied for the electromagnet may be controlled by the controller of the robot. The electromagnet is especially suitable for hold and release the twistlocks made of ferromagnetic material, such as iron. The electromagnet may be energized by supplying current to the electromagnet.

In one embodiment, during the moving of the pick-up arrangement 21, the electromagnet may be energized. When the connecting member 23 arrives at the primary pick-up point, the twistlock 10 may be held by the pick-up arrangement 21, by magnetic attraction force. Another advantage of applying the electromagnet may be that the primary pick-up point may be determined roughly, and even if there is a distance between the connecting member 23 and the twistlock 10, the magnetic attraction force may drive the connecting member 23 to contact the twistlock 10, and thereby the connection of the connecting member 23 to the twistlock 10 may be made.

In phase (c), the level of the pick-up arrangement 21 may be continuously decreased till the twistlock 10 is held by the connecting member 23. In one embodiment, the pick-up arrangement 21 further comprises a sensor configured to generate an indicator for indicating that the twistlock 10 has been held by the connecting member 23. The sensor may comprise a sensor 28 coupled to the lines 24 and configured to generate the force information associated with connection of the twistlock 10 to the pick-up arrangement 21.

The transition from phase (c) to phase (d) shows the process of separating the twistlock 10 from the heap comprising a plurality of twistlocks. In one embodiment, in response to the determination that the twistlock 10 is held by the pick-up arrangement, the robot lifts the twistlock so as to separate the twistlock 10 from the heap comprising a plurality of twistlocks. In particular, the twistlock 10 may be lifted via the movement of the robotic arms or the winding of lines 24 of the pick-up arrangement 21 or in combination thereof.

During the lifting of the twistlock 10, the measurement for the force to lift the twistlock 10 may be generated by the sensor 28. Whether the first twistlock is lifted by the pick-up arrangement may be detected based on comparison between measurement of the lifting force and a threshold. The process of comparison may be performed by the robot. The threshold may be determined based on the weight of the connecting member 23 and a single twistlock. If the measurement of the lifting force is greater than the determined threshold by a certain amount, the robot may determine that the twistlock 10 is not lifted. If the measurement of the lifting force is approximately equal to the determined threshold, the robot may determine that the twistlock 10 is lifted. In response to the determination that the twistlock 10 is lifted, the robot may perform further operations to the lifted twistlock 10.

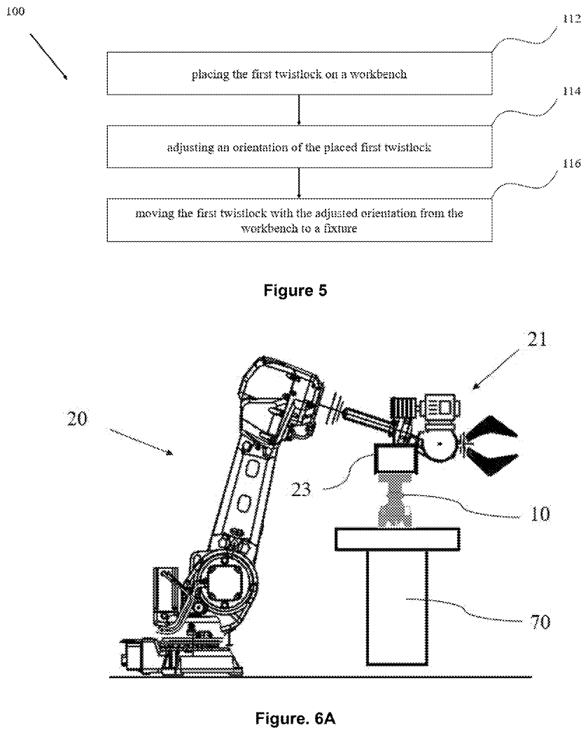

FIG. 5 illustrates a flowchart of further processes performed by the robot in FIG. 2A after the twistlock is separated from the heap.

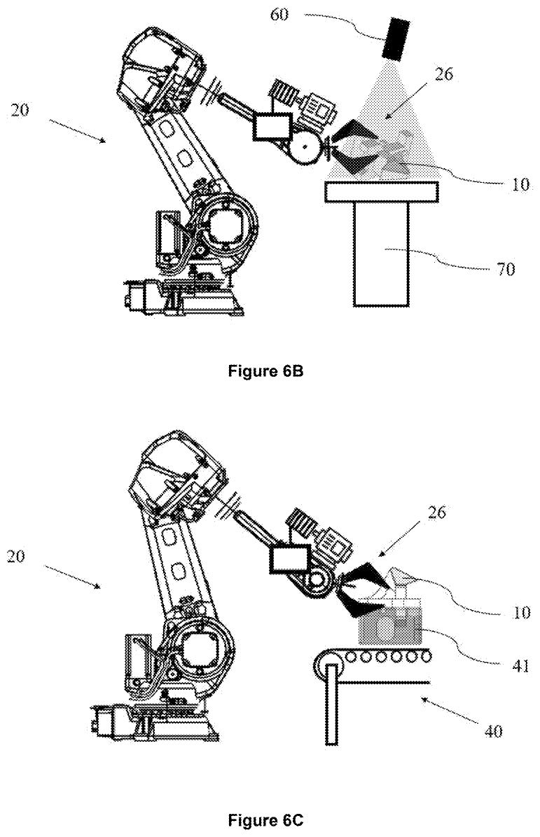

In addition to the processes in blocks 104-110, the method 100 may further comprise the processes in blocks 112-116. At block 112, the lifted twistlock 10 may be placed on a workbench by the robot 20. At block 114, an orientation of the placed first twistlock may be adjusted by the robot 20, in particular by an end effector 26 of the robot 20. At block 116, the first twistlock with the adjusted orientation may be moved from the workbench 70 to a fixture 41. The processes in blocks 112-116 may be discussed in more detail below with reference to FIGS. 6A-6C.

FIGS. 6A-6C illustrate the processes of performing operations to the twistlock by the robot in FIG. 2A. The processes illustrated in FIGS. 6A-6C correspond to blocks 112-116, respectively.

As shown by FIG. 6A, the twistlock 10 may be positioned and released on the workbench 70. In one embodiment, the robot may be configured to, in response to the determination that the twistlock 10 contacts the workbench 70, deenergize the electromagnet of the connecting member 23, and thereby the twistlock 10 may be released, and thereby placed on the workbench 70.

As shown by FIG. 6B, the placed twistlock 10 may be operated by the end effector 26 of the robot 20. In one embodiment, the robot 20 may be configured to, in response to the determination that the orientation of the twistlock 10, adjust the twistlock 10 by the end effector 26. The orientation of the twistlock 10 may be determined on the image from a camera. In one embodiment, the image of the twistlock 10 on the workbench 70 may be captured by a camera 60 from above the workbench 70. The camera 60 may be the same camera configured for capturing the image of the heap discussed above with reference to FIG. 2A, or a further camera communicated to the controller of the robot. The further camera may be integrated on the robot 20, or positioned above the workbench 70. The amount of adjustment of orientation may be determined based on a difference between a standard orientation and the determined orientation of the twistlock 10. The standard orientation of the twistlock may be predetermined, for example by user input. The robot 20 may be configured to grasp the twistlock 10 using the end effector 26 based on the determined amount of adjustment and rotate the end effector 26 grasping the twistlock 10 so as to change the direction of the central axis of the twistlock 10.

As shown by FIG. 6C, the twistlock 10 with the adjusted orientation may be moved by the robot 20 from the workbench 70 to a fixture 41. As an example, the fixture 41 may be coupled to a conveyor 40. In this way, the twistlock fed by the robot 20 may be deliver to a position for performing a further process, e.g. of automatic feeding. The fixture 41 may be configured to only receive the twistlock with a standard orientation, such that the further process of automatic feeding twistlocks can be facilitated. In one embodiment, the fixture 41 comprises a cavity configured to receive a cone of the twistlock. The cavity of the fixture may be dimensioned such that only the cone of the twistlock may enter into the cavity. The fixture may further be configured to, when the cone of the twistlock is received by said cavity, support the twistlock via a top surface of the fixture.

In this implementation, the processes illustrated in FIGS. 6B-6C may performed by the same robot used for separating the twistlock from the heap comprising a plurality of twistlocks. In another embodiment, these processes may be performed by a further robot. The further robot may be the robot equipped with the end effector. Optionally, the further robot may be the same type of robot discussed above with reference to FIG. 2A.

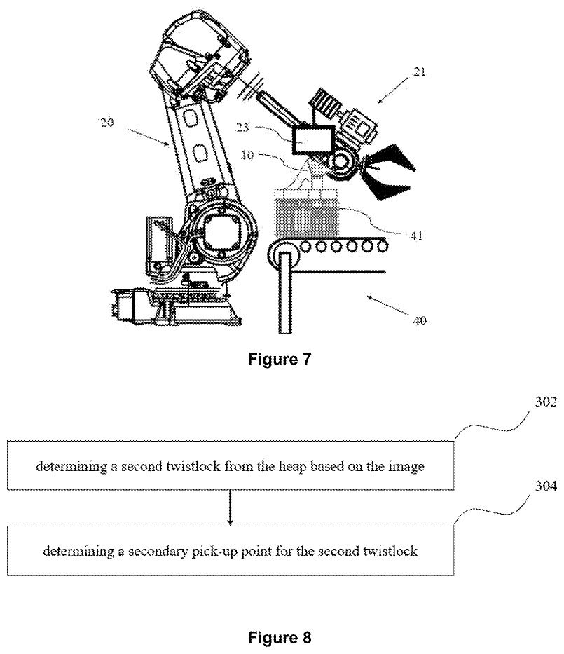

FIG. 7 illustrates the further processes of performing operations to the twistlock by the robot in FIG. 2A. The robot 20 may be further configured to move, in response to a determination that the twistlock 10 is lifted, the first twistlock to a fixture 41, as illustrated by FIG. 7. The fixture 41 may be configured to receive twistlocks 10 with various orientations. As an example, the fixture 41 may be coupled to a conveyor 40. In this way, the twistlock fed by the robot 20 may be delivered to a position for performing a further process. The further process may comprise adjusting the orientation of the twistlocks in the fixture 41. The further process may be performed by a further robot.

Additionally, or alternatively, the robot 20 may be configured to determine, before or during the process of moving the twistlock 10 to the fixture 41, whether an additional twistlock is lifted together with the twistlock 10. The robot 20 may configured to determine that an additional twistlock is lifted together with the twistlock based on the measurement for the force to lift the twistlock. The lifting of the additional twistlock should be prevented because there may be unreliable connection, such as entanglement, between the additional twistlock and the twistlock held by the pick-up arrangement, and the unpredictability of falling of the additional twistlock may put the operating area at risk.

Referring to FIG. 4, the measurement for the force to lift the twistlock 10 may be generated by the sensor 28. Whether the additional twistlock is lifted by the pick-up arrangement may be detected based on comparison between measurement of the lifting force and a second threshold. The process of comparison may be performed by the robot. The second threshold may be determined based on the weight of the connecting member 23, and two twistlocks. If the measurement of the lifting force is less than the determined second threshold by a certain amount, the robot may determine that the additional twistlock is not lifted. If the measurement of the lifting force is approximately equal to the determined second threshold, the robot may determine that the additional twistlock is lifted. The robot may be configured to, in response to the determination that the additional twistlock is lifted, move the lifted twistlocks back to the heap. Later, the robot may restart the processes as illustrated in FIG. 2C, or further processes as illustrated herein.

FIG. 8 illustrates a flowchart of further processes performed by the robot provided by the present disclosure. At block 302, a second twistlock from the heap may be determined by the robot based on the image. At block 304, a secondary pick-point for the second twistlock may be determined. In one embodiment, the processes in blocks 302 and 304 may be performed simultaneously when performing the processes determining the first twistlock and the primary pick-up point, respectively. The robot may be configured to determine whether to move on to separate the first twistlock based on the comparison between the primary pick-up point and the secondary pick-up point. The comparison may be performed based on evaluating whether the primary pick-up point or the secondary pick-up point is easier to be accessed by the pick-up arrangement. In particular, the operating path of the pick-up arrangement to access the primary pick-up point and the secondary pick-up point may be assigned a respective score. The respective score may be determined based on a distance from the pick-up arrangement to the pick-up point. When determining the respective score, the number of twistlocks surrounding the pick-up point, namely, the primary pick-up point and the secondary pick-up point, may also be taken into consideration.

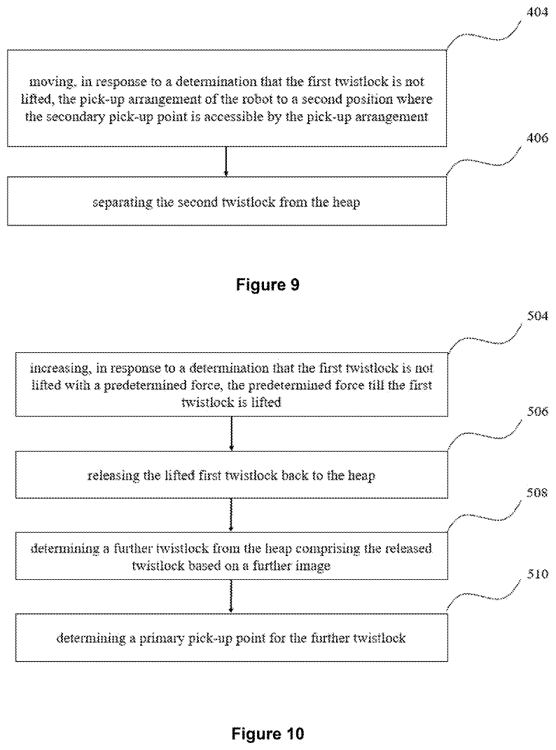

As an alternative, the processes in blocks 302 and 304 may be performed in response to the determination that the first twistlock is not lifted. The second twistlock may serve as a candidate twistlock for the first twistlock. That is, the second twistlock may not be accessed by the pick-up arrangement of the robot at first time. FIG. 9 illustrates a flowchart of further processes performed by the robot provided by the present disclosure. At block 404, in response to a determination that the first twistlock is not lifted, moving the pick-up arrangement of the robot 20 to second position where the secondary pick-up point is accessible by the pick-up arrangement. At block 406, separating the second twistlock from the heap. The processes of blocks 404-406 may be performed for example, by the robot discussed above with reference to FIG. 2A.

FIG. 10 illustrates a flowchart of further processes performed by the robot provided by the present disclosure.

At block 504, in response to a determination that the first twistlock is not lifted with a predetermined force, increasing the predetermined force till the first twistlock is lifted. In case that the first twistlock is not lifted with a predetermined force, the robot determines that the first twistlock is stuck in the heap. The robot then may use a greater lifting force to separate the twistlock from the heap so as to update the architecture of heap. In one embodiment, the predetermined force may be increased by increasing the output power of the motor 22 of the pick-up arrangement, or moving the robotic arm 25 coupled to the pick-up arrangement 21 upwards or in combination.

At block 506, the lifted first twistlock may be released back to the heap. By performing the processes in blocks 504 and 506, the architecture of heap may be updated. After the architecture of heap is updated, some twistlocks buried in the former architecture may be revealed, and some twistlocks may be disentangled with the other twistlocks.

At block 508, a further twistlock from the heap comprising the released twistlock may be determined based on a further image. The further image may be captured from above the heap comprising the released twistlock, i.e. the heap having an updated architecture. In one embodiment, the further image may be captured by the camera 30 of robot 20 illustrated in FIG. 2A.

At block 510, a primary pick-up point for the further twistlock may be determined. The primary pick-up point for the further twistlock may be accessed by the pick-up arrangement, and then the further twistlock may be separated from the heap by the robot. The process of determining the primary pick-up point for the further twistlock may be similar to the process of determining the primary pick-point for the first twistlock.

It should be appreciated that the above detailed embodiments of the present disclosure are only for exemplifying or explaining principles of the present disclosure and do not limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A method for feeding twistlocks by a robot, comprising:
determining a first twistlock from a heap including a plurality of twistlocks based on an image of the heap,
determining a primary pick-up point for the first twistlock,
moving a pick-up arrangement of the robot to a first position where the primary pick-up point is accessible by the pick-up arrangement, and
separating the first twistlock from the heap.

2. The method of claim 1, further comprising:
placing the first twistlock on a workbench,
adjusting an orientation of the placed first twistlock, and
moving the first twistlock with the adjusted orientation from the workbench to a fixture.

3. The method of claim 1, further comprising:
moving, in response to a determination that the first twistlock is lifted, the first twistlock to a fixture.

4. The method of claim 3, wherein moving the first twistlock to the fixture comprises:
determining whether an additional twistlock is lifted together with the first twistlock.

5. The method of claim 1, further comprising:
determining a second twistlock from the heap based on the image, and
determining a secondary pick-up point for the second twistlock.

6. The method of claim 5, further comprising:
moving, in response to a determination that the first twistlock is not lifted, the pick-up arrangement of the robot to a second position where the secondary pick-up point is accessible by the pick-up arrangement, and
separating the second twistlock from the heap.

7. The method of claim 1, wherein the image comprises characteristic information representing a height distribution diagram of the heap.

8. The method of claim 7, wherein determining the first twistlock from the heap comprises:
selecting, based on the characteristic information, a twistlock at or near a peak value in the height distribution diagram of the twistlocks as the first twistlock.

9. The method of claim 1, wherein the first twistlock is a twistlock closest to a peak of the heap.

10. The method of claim 1, wherein the image comprises the image captured from right above the heap.

11. The method of claim 1, wherein the image comprises an image captured by a 3D camera.

12. The method of claim 1, further comprising:
Increasing, in response to a determination that the first twistlock is not lifted with a predetermined force, the predetermined force till the first twistlock is lifted,
releasing the lifted first twistlock back to the heap,
determining a further twistlock from the heap including the released twistlock based on a further image, and
determining a primary pick-up point for the further twistlock.

13. The method of claim 1, wherein the pick-up arrangement comprises a connecting member including an electromagnet configured to generate a magnetic attraction force.

14. A robot configured to perform a method for feeding twistlocks, comprising:
determining a first twistlock from a heap including a plurality of twistlocks based on an image of the heap,
determining a primary pick-up point for the first twistlock,
moving a pick-up arrangement of the robot to a first position where the primary pick-up point is accessible by the pick-up arrangement, and
separating the first twistlock from the heap.

15. A feeding system comprising:
a robot for feeding twistlocks, comprising:
determining a first twistlock from a heap including a plurality of twistlocks based on an image of the heap,
determining a primary pick-up point for the first twistlock,
moving a pick-up arrangement of the robot to a first position where the primary pick-up point is accessible by the pick-up arrangement,
separating the first twistlock from the heap, and
a conveyor configured to deliver a twistlock fed by the robot.
